(19) United States
(12) Patent Application Publication
(10) Pub. No.: US 2010/0258148 A1
(43) Pub. Date: Oct. 14, 2010

(54) Roller Cover Cleaning System and Method

(75) Inventors: Lawrence Arthur Anderson, Cincinnati, OH (US); Jan Allen Detherage, Liberty Township, OH (US); Steven Ray Long, Liberty Township, OH (US)

Correspondence Address: FROST BROWN TODD, LLC, 2200 PNC CENTER, 201 E. FIFTH STREET, CINCINNATI, OH, 45202, US

(73) Assignee: LJ&S PRODUCTS LLC, Cincinnati, OH (US)

(21) Appl. No.: 12/756,496

(22) Filed: Apr. 8, 2010

Related U.S. Application Data
(60) Provisional application No. 61/261,063, filed on Nov. 13, 2009.
(60) Provisional application No. 61/167,623, filed on Apr. 8, 2009.

(51) Int. Cl. B08B 3/00

(52) U.S. Cl. 134/157

(57) ABSTRACT

A roller cover cleaning system comprises a handle and a roller cover frame. The handle comprises a gripping portion, an attachment member, a connecting member, and an axle extending from the attachment member. The roller cover frame engages the axle such that the roller cover frame is able to rotate freely about the axle. An alternate roller cover cleaning system comprises a frame, a first roller, a second roller, and a driving feature. The first roller is positioned between a first end plate and a second end plate of the frame and is configured to freely rotate about its longitudinal central axis. The second roller is positioned between the first end plate and the second end plate and is configured to freely rotate about its longitudinal central axis. The driving feature is configured to be in mechanical communication with at least one of the first roller or the second roller.

### PRIORITY

This application claims priority to U.S. Provisional Patent Application Ser. No. 61/167,623, filed Apr. 8, 2009, entitled “Paint Roller Cover Cleaning Device and System,” and U.S. Provisional Patent Application Ser. No. 61/261,063, filed Nov. 13, 2009, entitled “Multi-Roller Paint Roller Cover Cleaning Device and System,” the disclosures of which are incorporated by reference herein.

### BACKGROUND

Rolling devices and associated roller covers have been used for many years to apply a wide variety of substances to various surfaces, including but not limited to paint, primer, stain, sealer, etc. While rollers and roller covers may facilitate the application process, the roller covers may be difficult and messy to clean. Attempts to clean the roller covers may result in the user getting paint or some other substance on his hands and clothing and on surrounding surfaces. In addition, a user may use a large amount of water during the attempt to clean the roller cover. In order to avoid the problems associated with cleaning a roller cover, a user may simply discard the roller cover after a single use, which can increase the cost of painting, priming, staining, sealing, etc. and may result in roller covers being unnecessarily added to landfills.

While numerous devices and methods have been made and used to clean roller covers, it is believed that no one prior to the inventors has made or used the invention described herein.

### BRIEF DESCRIPTION OF THE DRAWINGS

While the specification concludes with claims that particularly point out and distinctly claim the invention, it is believed the expressly disclosed exemplary embodiments of the present invention can be understood from the following description taken in conjunction with the accompanying drawings, in which like reference numerals identify the same elements. The drawings and detailed description which follow are intended to be merely illustrative of the expressly disclosed exemplary embodiments and are not intended to limit the scope of the invention as set forth in the appended claims. In the drawings:

FIG. 1 depicts a front view of an exemplary roller cover cleaning device;

FIG. 2 depicts an exploded assembly view of the roller cover cleaning device of FIG. 1;

FIG. 3 depicts a perspective view of a portion of the roller cover cleaning device of FIG. 1;

FIG. 4 depicts a partial perspective view of an end cap and external driving feature of the roller cover cleaning device of FIG. 1;

FIG. 5 depicts a perspective view of an exemplary roller cover;

FIG. 6 depicts a front view of an exemplary roller cover cleaning system that includes the roller cover cleaning device of FIG. 1 and an exemplary internal drive shaft partially inserted into the axle of the roller cover cleaning device of FIG. 1;

FIG. 7 depicts a perspective view of an exemplary roller cover cleaning system that includes the roller cover cleaning device of FIG. 1, a roller cover, and a receptacle;

FIG. 8 depicts a perspective view of a the roller cover cleaning system of FIG. 7 including a drive unit with an internal drive shaft fully inserted into the roller cover cleaning device;

FIG. 9 depicts a front, cross-sectional view of an alternate roller cover cleaning system that includes the roller cover cleaning device of FIG. 1, an exemplary receptacle, and an exemplary external drive unit;

FIG. 10 depicts a perspective view of the roller cover cleaning system of FIG. 7 and an exemplary covering member;

FIG. 11 depicts the roller cover cleaning system of FIG. 10 with the covering member engaged with the receptacle;

FIG. 12 depicts a front view of an alternate exemplary roller cover cleaning device;

FIG. 13 depicts a perspective top view of a portion of the roller cover cleaning device of FIG. 12;

FIG. 14 depicts a side view of the roller cover cleaning device of FIG. 12;

FIG. 15 depicts a perspective rear view of the roller cover cleaning device of FIG. 12;

FIG. 16 depicts a perspective front view of an exemplary roller cover cleaning system including the roller cover cleaning device of FIG. 12 and a receptacle;

FIG. 17 depicts a perspective front view of the roller cover cleaning system of FIG. 16 with the roller cover cleaning device inserted into the receptacle;

FIG. 18 depicts a partial perspective view of the roller cover cleaning system of FIG. 16 along with a driving device being used to clean a roller cover;

FIG. 19 depicts a front view of an alternate exemplary rolling device;

FIG. 20 depicts a perspective view of the rolling device of FIG. 19 being used as part of the roller cover cleaning system of FIG. 17 with a drive unit;

FIG. 21 depicts a perspective view of the roller cover cleaning system of FIG. 19 with including an alternate engagement member and a drive unit.

### DETAILED DESCRIPTION

The following description should not be used to limit the scope of the present invention. Other examples, features, aspects, embodiments, and advantages of the invention will become apparent to those skilled in the art from the following description, which includes by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive. It should therefore be understood that the inventor contemplates a variety of embodiments that are not explicitly disclosed herein.

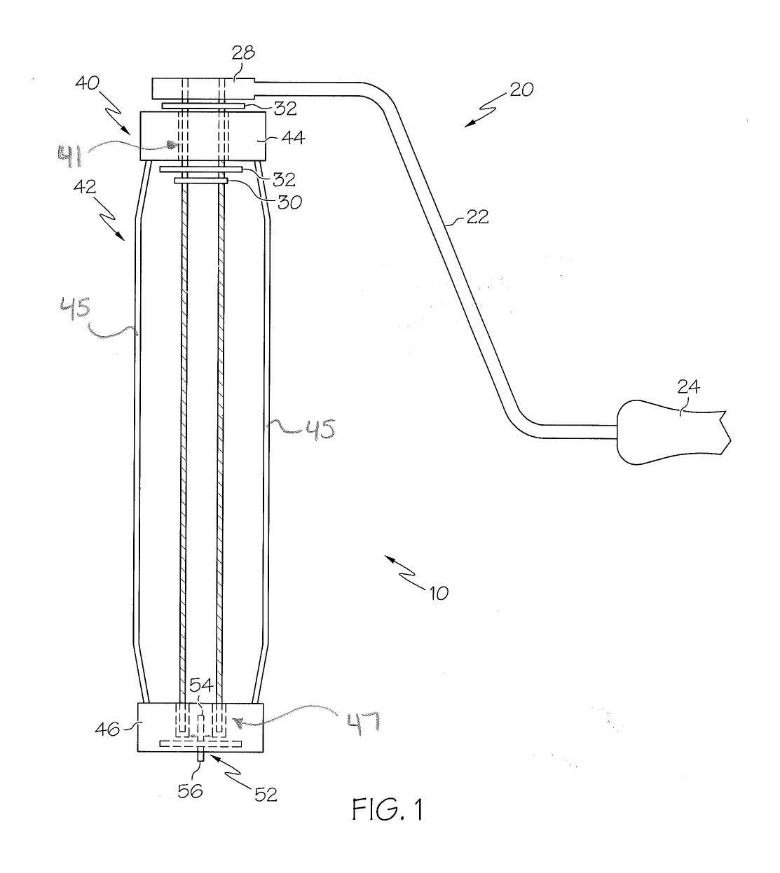

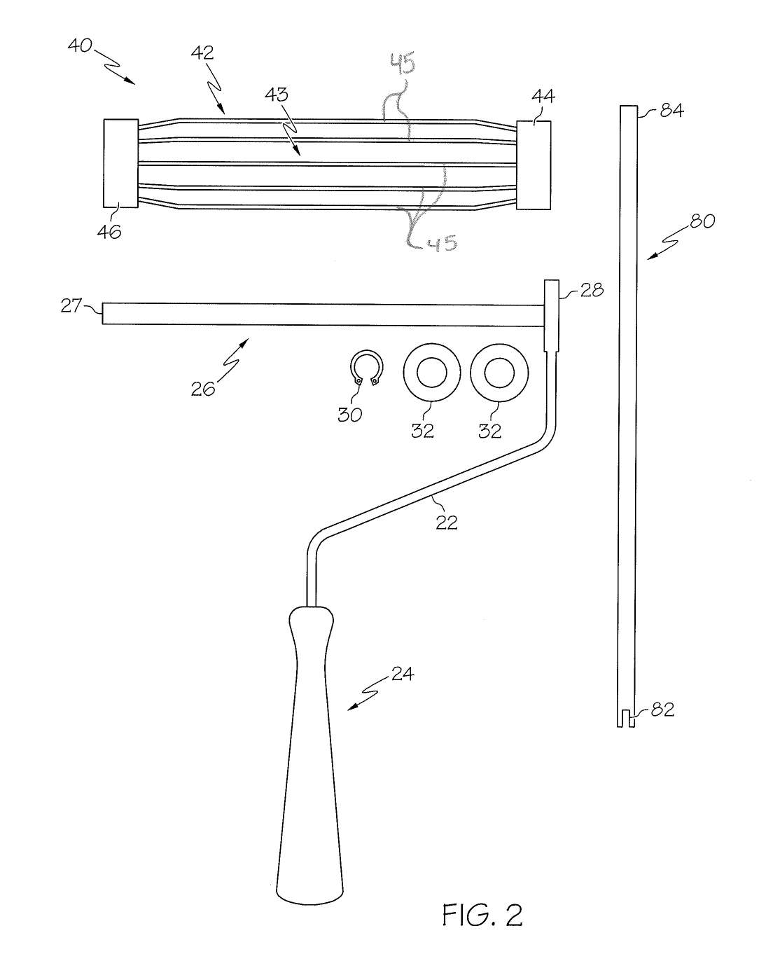

A As shown in FIGS. 1-2, an exemplary roller cover cleaning device (10) comprises a roller handle (20) and a roller cover frame (40). In the illustrated version, roller handle (20) comprises a connecting member (22) extending between a gripping portion (24) at a first end and an attachment member (28) at a second end. Attachment member (28) may comprise a separate component from connecting member (22), or connecting member (22) and attachment member (28) may be integral with each other. An axle (26) extends substantially perpendicularly from attachment member (28). As shown, axle (26) comprises a hollow shaft configured to receive an internal drive shaft (80), described in more detail below. Attachment member (28) may comprise a drive shaft opening (29) that is configured to be aligned with the hollow interior cavity of axle (26). Specifically, in the illustrated embodiment the central axis of drive shaft opening (29) is aligned with the longitudinal central axis of axle (26). In an alternate embodiment, axle (26) may comprise a substantially solid shaft. Axle (26) may be fixedly attached to attachment member (28) such that axle (26) does not rotate, although this is not required. The attachment may be achieved using one or more fasteners, welding, or any other suitable device or method. In one embodiment, axle (26) may be removably and/or rotatably attached to connecting member (22). Axle (26), attachment member (28) and connecting member (22) may comprise any suitable material, including but not limited to fiberglass, wood, steel, soft or hardened carbon steel, stainless steel, aluminum, brass, copper, bronze, other suitable metals, polymeric plastics, polytetrafluoroethylene, polyethylene, polypropylene, nylon, and other suitable plastics.

As shown, gripping portion (24) is positioned along a first end of connecting member (22). Gripping portion (24) may comprise a plurality of undulations configured to facilitate grasping of the same. Alternatively, a gripping portion may be ergonomically molded to correspond to the shape of a user's fingers or it may comprise other features such as recesses, ridges, knurling, etc., or no such features at all. Gripping portion (24) may comprise any suitable material, including but not limited to fiberglass, wood, foam, rubber, soft or hardened carbon steel, aluminum, brass, copper, bronze, other suitable metals, polymeric plastics, polytetrafluoroethylene, polyethylene, polypropylene, nylon, and other suitable plastics.

In the illustrated embodiment, roller cover frame (40) comprises a substantially cylindrical cage (42) positioned between a first end cap (44) and a second end cap (46). While cage (42) comprises a plurality of rods (45) forming a hollow cylinder comprising an interior cavity (43) in the illustrated embodiment, it will be appreciated that cage (42) may comprise a substantially solid member having an interior cylindrical cavity or have any other suitable configuration in alternate embodiments. As shown, first end cap (44) and second end cap (46) are positioned on opposite ends of roller cover frame (40). First end cap (44) and second end cap (46) may be fixedly secured to cage (42) such that first end cap (44), second end cap (46), and cage (42) rotate unitarily. First end cap (44) and second end cap (46) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, and other suitable plastics. In the illustrated example, first end cap (44) comprises an axial opening (43) that extends through first end cap (44) along the central axis of first end cap (44), such that the axial opening (41) is configured to receive axle (26) and allow first end cap (44) to be positioned substantially adjacent to attachment member (28).

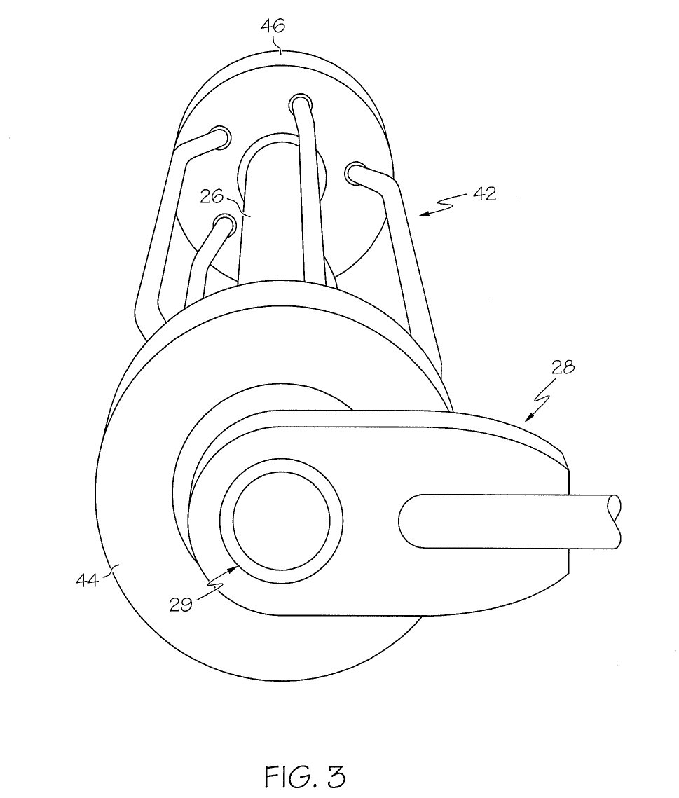

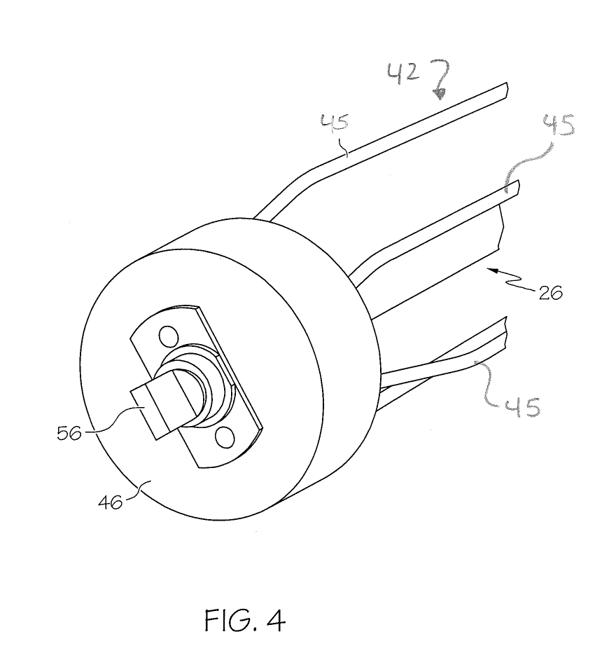

Turning to FIGS. 1-4, second end cap (46) comprises an axial recess (47), which extends partially through second end cap (46) along the central axis of second end cap (46). Of course, axial recess (47) may extend entirely through second end cap (46) in an alternate embodiment. In the illustrated version, axial recess (47) comprises a circular cross-section having an outer rim configured to receive the free end of axle (26), but any suitable cross-section may be used. Axial recess (47) is configured to receive the free end (27) of axle (26).

In this example, second end cap (46) further comprises a driving feature (52) configured to engage a drive shaft, as will be described in more detail below. As shown, driving feature (52) comprises an interior engagement feature (54) and an exterior engagement feature (56). In this embodiment, interior engagement feature (54) comprises a rectangular member configured to project inwardly along the central axis of second end cap (46) into axial recess (47). Similarly, exterior engagement feature (56) comprises a rectangular member configured to project outwardly substantially perpendicular to an outer surface of the second end cap (46) along the central axis of second end cap (46). It will be appreciated by those of ordinary skill in the art that interior engagement feature (54) and exterior engagement feature (56) may comprise any suitable structure of any suitable dimensions configured to engage a drive shaft or external drive unit, including but not limited to a member (as shown in FIGS. 1-4), a projection, a recess, and a set screw head. In addition, interior engagement feature (54) and exterior engagement feature (56) may comprise any suitable shape, including but not limited to rectangular, circular, hexagonal, square, or any other shape. Also, although the illustrated embodiment depicts interior engagement feature (54) and exterior engagement feature (56) comprising similar structures and shapes, alternate embodiments may include an interior engagement feature comprising a different structure and/or shape than the corresponding exterior engagement feature. The illustrated embodiment comprising both interior engagement feature (54) and exterior engagement feature (56) is configured to engage both an external drive source and an internal drive source, as described below. Alternate embodiments may include only one of interior engagement feature (54) or exterior engagement feature (56). Also, in an alternate embodiment, interior engagement feature (54) and exterior engagement feature (56) may be positioned somewhere other than along the central axis of second end cap (46), provided interior engagement feature (54) and exterior engagement feature (56) are configured to engage a drive shaft or external drive unit and communicate rotational force to roller cover frame (40).

As shown in FIGS. 1-2, roller cover cleaning device (10) may be assembled by mounting roller cover frame (40) to roller handle (20). In the illustrated example, roller cover cleaning device (10) is configured such that roller cover frame (40) may be mounted to roller handle (20) by inserting axle (26) through axial opening (41) in first end cap (44), through the interior cavity (43) of cage (42) and into the axial recess in second end cap (46). In this version, roller cover frame (40) is configured to rotate freely about axle (26). As shown, roller cover frame (40) is secured to axle (26) by inserting a snap-ring (30) into a groove in axle (26) located adjacent to the interior face of first end cap (44). Snap-ring (30) may be configured to prevent roller cover frame (40) from disengaging axle (26). Of course, any suitable structure may be used to engage axle (26) and roller cover frame (40), including but not limited to a snap ring and an e-clip. Roller cover frame (40) may be disengaged from roller handle (20) by removing snap ring (30) and sliding roller cover frame (40) off of axle (26). Washers (32) may also be installed along axle (26) adjacent to the interior and exterior faces of first end cap (44), although these are not required.

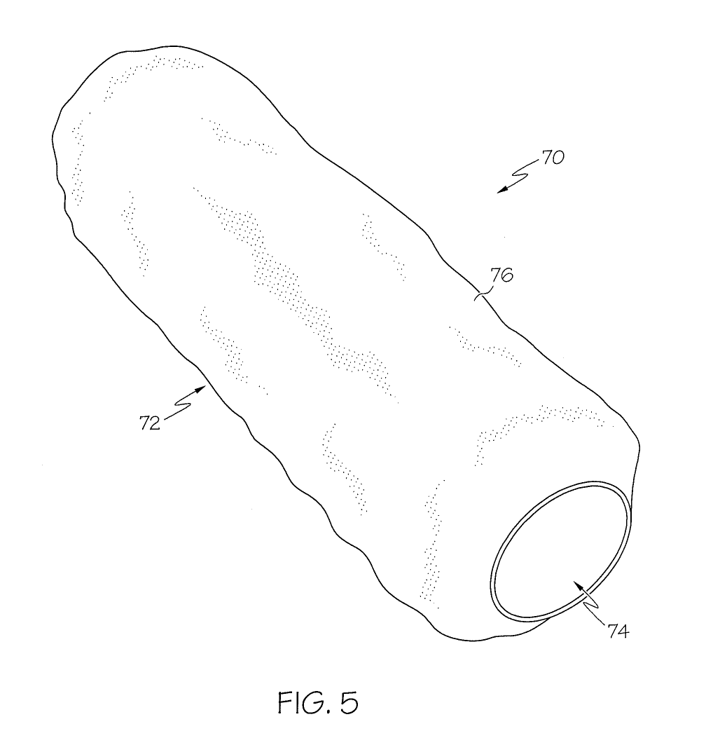

In the illustrated embodiment, roller cover cleaning device (10) is configured to work in conjunction with a roller cover or sleeve, which is well known within the art. An exemplary roller cover (70) is depicted in FIG. 5. The dimensions of axle (26) and roller cover frame (40) may be varied in order to accommodate any suitable style and/or size roller cover, including but not limited to roller covers that are about 4 inches, 7 inches, 9 inches, 14 inches, and 18 inches in length. As shown in FIG. 5, roller cover (70) comprises a tubular member (72) having an interior cylindrical cavity (74) and an outer surface (76) configured to apply a substance (paint, primer, stain, sealer, etc.) to walls and other surfaces. Outer surface (76) may comprise any suitable texture configured to provide one or more desired effects when the substance is applied to a surface using roller cover (70). Roller cover (70) may be assembled with roller cover cleaning device (10) by inserting roller cover frame (40) axially into interior cylindrical cavity (74) along the central axis of tubular member (72) and sliding roller cover (70) longitudinally along roller cover frame (40). Upon assembly, roller cover (70) may be configured to rotate unitarily with roller cover frame (40). Once assembled, roller cover cleaning device (10) and roller cover (70) may be used to apply paint or any other suitable substance to a desired surface. For example, a user may at least partially cover roller cover (70) with paint and then apply the paint to a surface, such as a wall, by rolling the roller cover (70) along the surface, thereby transferring the paint from outer surface (76) of the roller cover (70) to the desired surface.

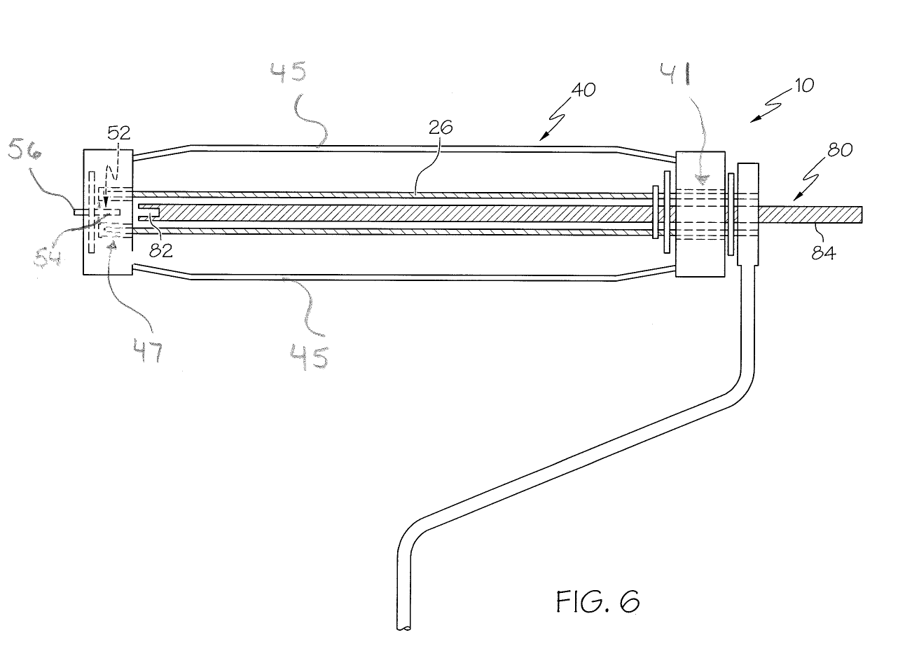

FIG. 6 depicts a roller covering cleaning system comprising roller cover cleaning device (10) and internal drive shaft (80). In particular, in FIG. 6 internal drive shaft (80) is shown prior to engagement of interior engagement feature (54). Internal drive shaft (80) comprises an engagement end (82) and a motor attachment end (84). Engagement end (82) may be configured to engage driving feature (52). More specifically, engagement end (82) may be configured to engage interior engagement feature (54) in order to communicate rotational force to roller cover frame (40) and cause roller cover frame (40) to rotate about axle (26). In the illustrated embodiment, engagement end (82) comprises a rectangular slot configured to receive interior engagement feature (54). Of course, engagement end (82) may comprise any suitable structure or shape, provided the structure and shape corresponds to interior engagement feature (54) such that an adequate engagement is provided between engagement end (82) and interior engagement feature (54). Engagement end (82) may be configured to engage exterior engagement feature (56), although this is not required.

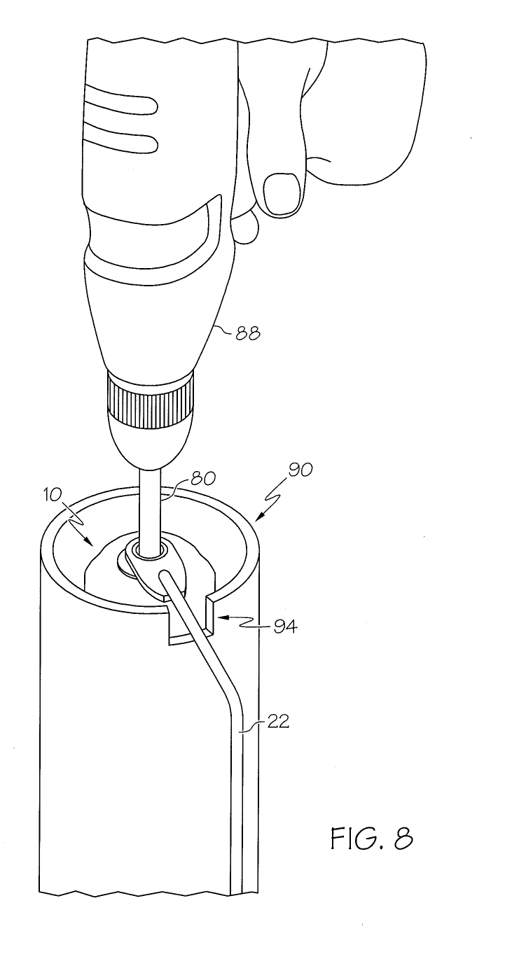

In the illustrated embodiment, motor attachment end (84) is configured to be attached to a drive unit (an example of which is shown in FIG. 8) configured to cause internal drive shaft (80), and, correspondingly, roller cover frame (40), to rotate about the longitudinal central axis of internal drive shaft (80). The drive unit may comprise a suitably adapted and mounted general purpose electric motor, or any other suitable device, including but not limited to a hand-held drill, a cordless battery powered hand-held drill, a corded electric drill, a hand powered device, a pneumatic device, a compressed air driven device, and a hydraulic device, and a low voltage electric motor.

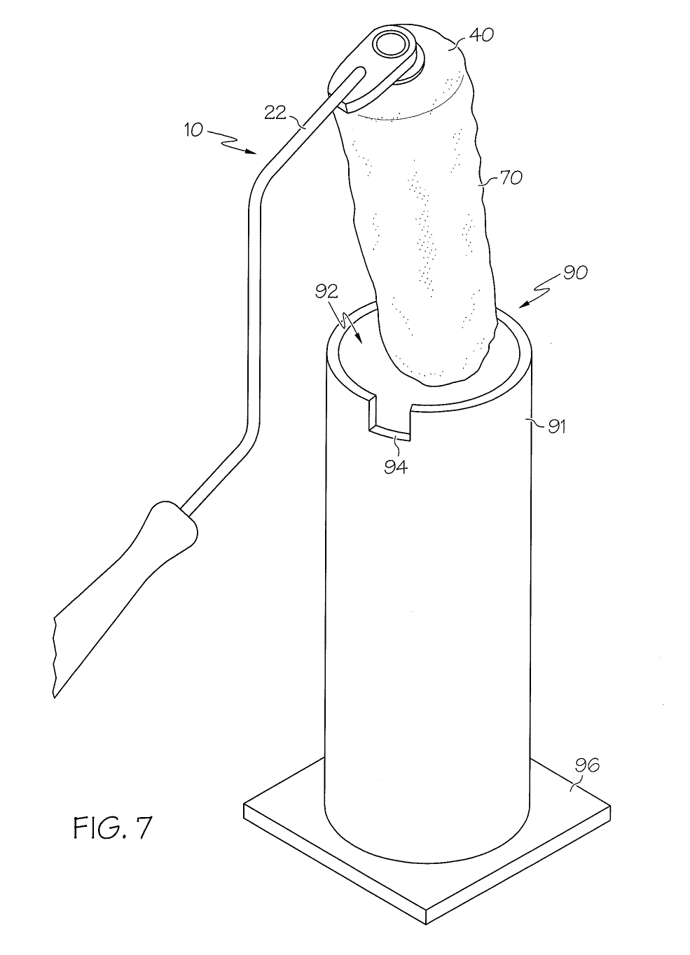

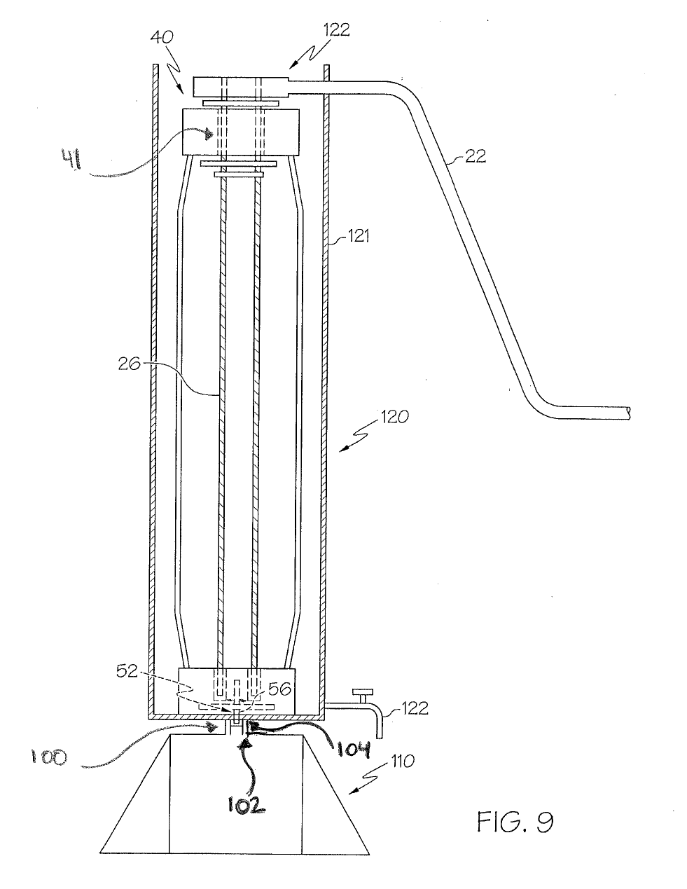

As shown in FIG. 7, a roller cover cleaning system comprises roller cover cleaning device (10) being used in conjunction with a cleaning receptacle (90). Once roller cover (70) has been inserted into receptacle (90), roller cover cleaning device (10) may be rotated using an internal drive shaft (80) and an associated drive unit (88), as shown in FIG. 8 similar to the embodiment described above. FIG. 9 depicts an alternate receptacle (120), which may be similar to receptacle (90), wherein roller cover cleaning device (10) is rotated using an external drive shaft (100) and alternate drive unit (110).

As shown, receptacle (90) comprises a cylindrical tubular member (91) configured to receive roller cover frame (40) and roller cover (70) into an interior cavity (92) and allow roller cover frame (40) and roller cover (70) to rotate freely therein. Receptacle (90) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, polyvinyl chloride (PVC) and other suitable plastics. In one embodiment, cylindrical tubular member (91) comprises a piece of polyvinyl chloride (PVC) plastic tubing having an inner diameter of 3 inches. Of course, receptacle (90) may have any suitable dimensions. Receptacle (90) may further comprise a base member (96) configured to support cylindrical tubular member (91). Base member (96) may comprise the same material as receptacle (90), although this is not required. Base member (96) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, polyvinyl chloride (PVC) and other suitable plastics. Cylindrical tubular member (91) may be fixedly or releasably attached to base member (96). Receptacle (90) may be configured to contain a suitable amount of water in order to facilitate the cleaning process and a drain (122) configured to drain the water out of receptacle (90). As shown in FIGS. 7-8, receptacle (90) further comprises a notch (94) in its upper edge configured to support a portion of connecting member (22) when roller cover frame (40) and roller cover (70) are inserted into interior cavity (92) of receptacle (90). In the illustrated version, notch (94) is configured to allow the top edge of roller cover (70) to remain below the upper rim of cylindrical tubular member (91) during cleaning, thereby helping to prevent water, paint, and other liquids and debris from spattering the surrounding area. Although notch (94) comprises a rectangular cutout in the illustrated embodiment, notch (94) may comprise any suitable shape, size or structure.

During use, a roller cover (70) may become at least partially covered with a substance, such as paint, primer, stain, sealer, etc. At least a portion of the substance may be removed from roller cover (70) by executing the following steps. First, roller cover cleaning device (10), with roller cover (70) attached to roller cover frame (40), may be inserted into receptacle (90). During insertion of roller cover cleaning device (10) a potion of connecting member (22) may be positioned within notch (94). A suitable amount of water may be poured into inner cavity (92) of receptacle (90) to facilitate the cleaning process. After inserting roller cover cleaning device (10) into receptacle (90), internal drive shaft (80) may be inserted into axle (26), as shown in FIGS. 8, such that engagement end (82) engages interior engagement feature (54). Motor attachment end (84) may be engaged with drive unit (88). Finally, the drive unit (88) may be actuated, thereby causing internal drive shaft (80), roller cover frame (40), and roller cover (70) to rotate unitarily. The force created by the rotation may cause the substance to separate from roller cover (70). In some embodiments, the user may be able to adjust the speed of rotation by manipulating a setting on drive unit (88). The rotation may be continued until the paint has been removed from roller cover (70) or for any suitable amount of time. The rotation may be carried out with or without water in the receptacle as desired by the user. In some other alternative versions, a liquid other than water may be used such as, but not limited to, liquid soap, soapy water, paint cleaner, paint thinner, etc. Once the rotation has been completed, the water may be drained from receptacle (90) via a drain, such as drain (122) in FIG. 9, or any other suitable method or device. Of course, the steps described above may be carried out in any suitable order, and one or more of the steps may be repeated as necessary.

FIG. 9 depicts an alternate roller cover cleaning system, wherein roller cover cleaning device (10) is associated with an external drive shaft (100) and an alternate drive unit (110). FIG. 9 depicts roller cover cleaning device (10) without roller cover (70). It will be appreciated that roller cover cleaning device (10) may be inserted into receptacle (120) with roller cover (70) engaged with roller cover frame (40). In this embodiment, external drive shaft (100) is in mechanical communication with alternate drive unit (110) at a first end (102), while the second end (104) of external drive shaft (100) is configured to engage driving feature (52). More specifically, second end (104) may be configured to engage exterior engagement feature (56) in order to communicate rotational force to roller cover frame (40) and cause roller cover frame (40) to rotate about axle (26). In the illustrated embodiment, second end (104) comprises a rectangular slot configured to receive exterior engagement feature (56). Of course, second end (104) may comprise any suitable structure or shape, provided the structure and shape corresponds to exterior engagement feature (56) such that an adequate engagement is provided between second end (104) and exterior engagement member (56).

As shown, first end (102) is configured to be attached to drive unit (110), which is configured to cause external drive shaft drive shaft (100), and, correspondingly, roller cover frame (40) and roller cover (70) (when included), to rotate about axle (26). Drive unit (110) may comprise an electric or battery operated motor adapted to be housed within drive unit (110). Drive unit (110) may comprise any suitable device, including but not limited to a hand-held drill, a cordless battery powered hand-held drill, a corded electric drill, a hand powered device, a pneumatic device, a compressed air driven device, and a hydraulic device, and a low voltage electric motor.

As shown in FIG. 9, drive unit (110) is configured to support a receptacle (120). Receptacle (120) may be similar to receptacle (90). Receptacle (120) may be fixedly or releasably secured to drive unit (110). In the illustrated embodiment, receptacle (120) comprises a cylindrical tubular member (121) configured to receive roller cover frame (40) and roller cover (70) (not shown in FIG. 9) into an interior cavity (122) and allow roller cover frame (40) and roller cover (70) to rotate freely therein. Receptacle (120) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, polyvinyl chloride (PVC) and other suitable plastics. Receptacle (120) may be configured to contain a suitable amount of water in order to facilitate the cleaning process and a drain (122) configured to drain the water out of receptacle (120). Drain (122) may comprise a spigot, a pipe, an opening, or any other structure suitable to empty at least some of the fluid contained in receptacle (120). In this version, receptacle (120) further comprises a notch, similar to notch (94), in its upper edge configured to support a portion of connecting member (22) when roller cover cleaning device (10) is inserted in receptacle (120). As shown, receptacle (120) further comprises an opening in the bottom surface of cylindrical tubular member (121) configured to allow exterior engagement member (56) to protrude through the opening.

A substance, including but not limited to paint, primer, stain, sealer, etc., may be removed from roller cover (70) by inserting roller cover cleaning device (10) into interior cavity (122) such that exterior engagement member (56) protrudes through the opening in the bottom surface of cylindrical tubular member (121) and engages second end (104) of external drive shaft (100). Drive unit (110) may then be initiated, thereby causing external drive shaft (100), roller cover frame (40), and roller cover (70) to rotate unitarily. The force created by the rotation may cause the substance to separate from roller cover (70). In some embodiments, the user may be able to adjust the speed of rotation by manipulating a setting on drive unit (110). The rotation may be continued until a satisfactory amount of the substance has been removed from roller cover (70) or for any suitable amount of time. The rotation may be carried out with or without water in receptacle (120) as desired by the user. Once the rotation has been completed, the water may be drained from receptacle (120) via drain (122) or any other suitable method or device. Of course, the steps described above may be carried out in any suitable order, and one or more of the steps may be repeated as necessary.

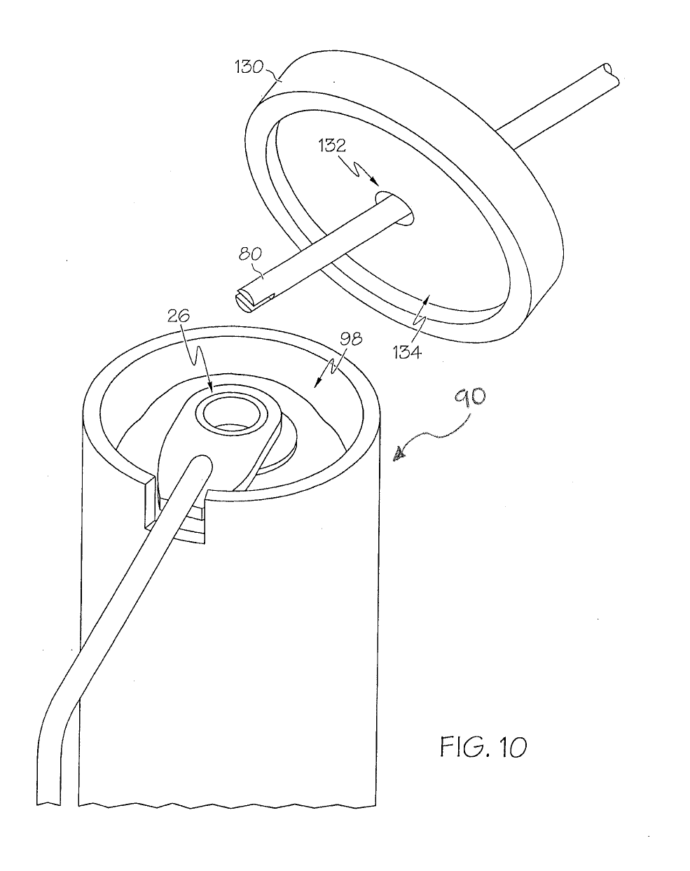

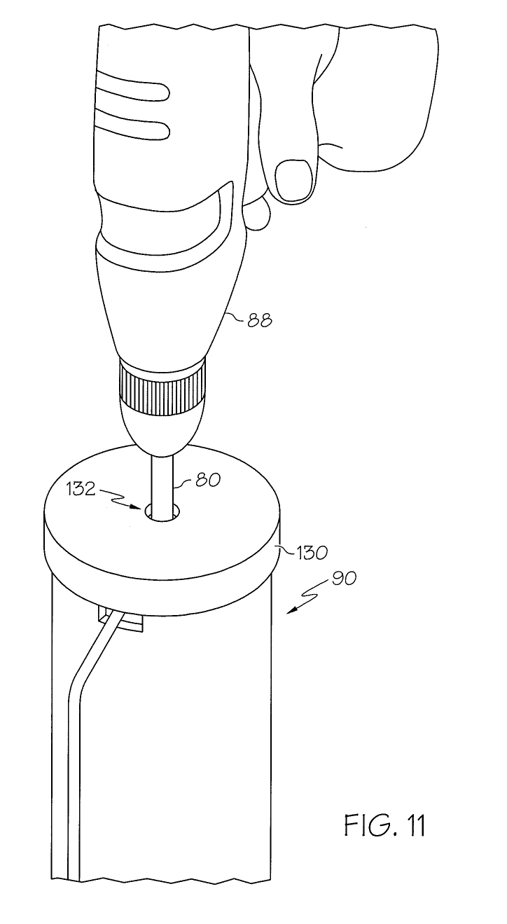

FIGS. 10-11 depict an alternate embodiment comprising a covering member (130). In the illustrated embodiment, covering member (130) is configured to be used in conjunction with receptacle (90). Of course, covering member (130) may be configured to be used with any suitable receptacle. Covering member (130) may comprise the same material as receptacle (90), although this is not required. Covering member (130) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, polyvinyl chloride (PVC) and other suitable plastics. As shown in FIGS. 10-11, covering member (130) is configured to be positioned on the open end (98) of receptacle (90). Covering member (130) comprises a central opening (132) configured to allow external drive shaft (80) to be inserted through central opening (132) and into axle (26). In an alternate embodiment (not shown), the covering member may comprise a notch, similar to notch (94), in the lip of the covering member. In such an embodiment, the notch may be configured to receive a portion of connecting member (22) and provide a secure fit between the covering member and the receptacle. Covering member (130) may be configured to prevent substances on the roller cover, water, and other debris from being dispersed out of receptacle (90) during cleaning. As shown, covering member (130) comprises an inner recessed area (134) configured to allow covering member (130) to engage open end (98) of receptacle (90). This is not required. Covering member (130) may be configured to provide a snap-fit engagement between covering member (130) and receptacle (90) or any other suitable type of engagement. In an alternate embodiment (not shown), covering member (130) and receptacle (90) may comprise corresponding sets of threads such that covering member may be threaded onto receptacle (90). In another alternative embodiment (not shown), covering member (130) may comprise a latch configured to releasably engage at least a portion of receptacle (90). In yet another alternate embodiment, covering member (130) may be attached to receptacle via a hinge, including but not limited to a living hinge, or any other suitable structure. A covering member may also be configured to engage receptacle (120). In such an embodiment the covering member may comprise a solid member without a central opening.

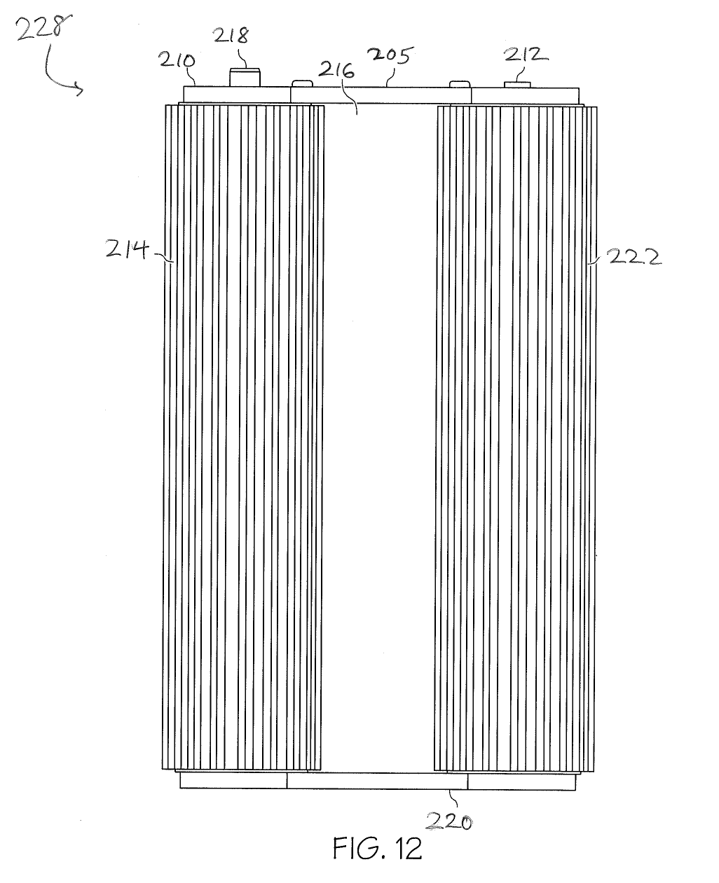

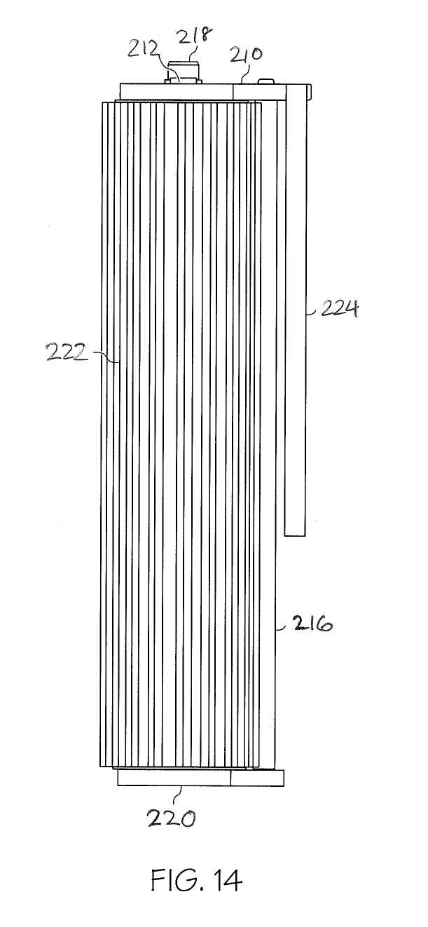

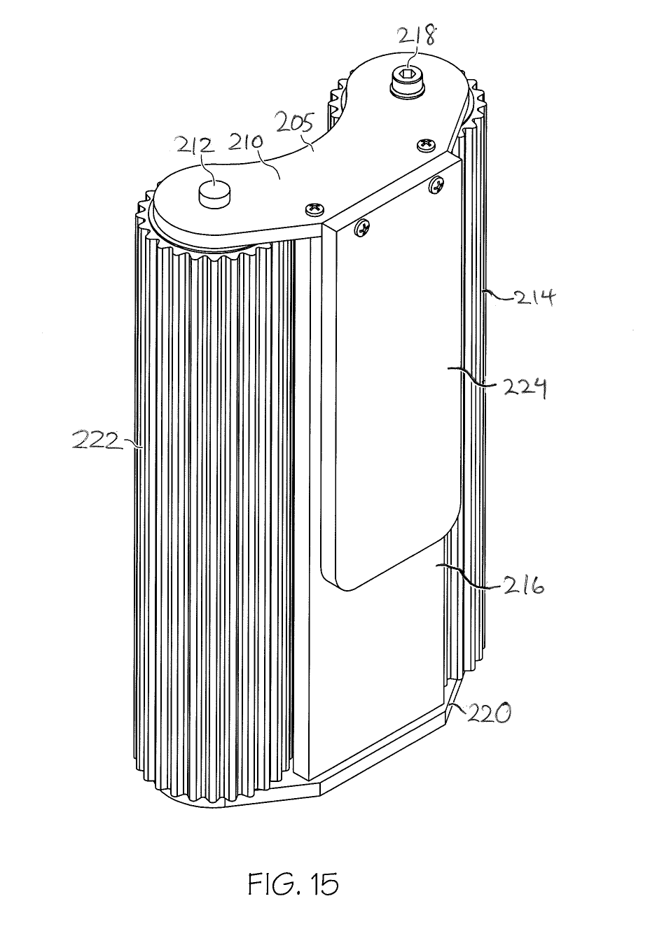

Turning now to FIGS. 12-15, an exemplary roller cover cleaning device (228) is shown comprising a frame (205), a first cleaning roller (214), and a second cleaning roller (222). The dimensions of roller cover cleaning device (228) and the associated components may be varied in order to accommodate any suitable style and/or size roller cover, including but not limited to roller covers that are about 4 inches, 7 inches, 9 inches, 14 inches, and 18 inches in length. In the illustrated version, frame (205) comprises a first end plate (210), a second end plate (220), and a back plate (216) that extends between first end plate (210) and second end plate (220). Frame (205) may further comprise a bracket (224) used to fixedly or releasably attach or hang roller cover cleaning device (228) on a receptacle (230) described in further detail below. Bracket (224) may be attached to first end plate (as shown in FIG. 14), back plate, or any other suitable portion of frame (205). Bracket (224) may comprise a substantially straight profile, a curved profile, or any other profile suitable to provide adequate engagement between roller cover cleaning device (228) and a receptacle. In some embodiments, bracket (224) may comprise a flexible material configured to conform to the profile of a receptacle. Bracket (224) may be omitted in some embodiments. In other versions frame (205) may be fixedly or releasably engaged with a receptacle (230) using a magnet, fastener, adhesive or any other suitable structure or method.

First end plate (210) may be constructed to engage one end of first cleaning roller (214) and second cleaning roller (222). First end plate (210) comprises a driving feature (218). Driving feature (218) comprises an external driving interface and an internal driving interface. The internal driving interface engages first cleaning roller (214). The external driving interface is configured to engage an external driving source. The external driving interface and the internal driving interface may be mechanically coupled such that rotation or movement of one results in rotation or movement of the other. The external driving source may comprise a suitably adapted and mounted general purpose electric motor, or any other suitable device, including but not limited to a hand-held drill, a cordless battery powered hand-held drill, a corded electric drill, a hand powered device, a pneumatic device, a compressed air driven device, a hydraulic device, and a low voltage electric motor. The external driving source may be fixedly or removably engaged with the external driving interface. Rotational motion generated by the external driving source may be communicated to the external driving interface, which communicates rotational motion to the internal driving interface, thereby causing first cleaning roller (214) to rotate.

In an alternate version, second end plate (220) may comprise a driving feature, such as driving feature (218), or first end plate (210) and second end plate (220) may each comprise individual driving features. Driving feature (218) may be mechanically coupled to second cleaning roller (222). In other examples, driving feature (218) may be mechanically coupled with first cleaning roller (214) and second cleaning roller (222). Alternatively, a first driving feature may be configured to interface with first cleaning roller (214), and a second driving feature may be configured interface with second cleaning roller (222). Driving feature (218) may also be configured to directly rotate a roller cover. Other suitable configurations will be apparent to those of ordinary skill in the art in view of the teachings herein.

In the illustrated version, first end plate (210) further comprises an engagement feature (212) con figured to receive and engage second cleaning roller (222). Engagement feature (212) may comprise an internal interface to engage second cleaning roller (222) and is further configured to allow second cleaning roller (222) to freely rotate. In some embodiment, engagement feature (212) and driving feature (218) may be in mechanical communication with each other, although this is not required. Engagement feature (212) and driving feature (218) may fit within a recessed portion of first end plate (210), although this is not required.

Alternatively, engagement feature (212) and driving feature (218) may be positioned at any suitable position along frame (205) as will be apparent to those of ordinary skill in the art in view of the teachings herein. For example, engagement feature (212) and driving feature (218) may be positioned at the top of frame (205) or may be positioned at the bottom of frame (205) or any other suitable position. In addition, engagement feature (212) and/or driving feature (218) may be positioned external to frame (205) or in any other suitable configuration as will be apparent to one of ordinary skill in the art in view of the teachings herein.

In the illustrated version, second end plate (220) may be constructed substantially similar to first end plate (210). Second end plate (220) may be positioned at an opposing end from first end plate (210) connected to first end plate (210) by back plate (216). In alternate versions, second end plate (220) may comprise a different shape than first end plate (210) or any shape suitable to allow roller cover cleaning device (228) to suitably function. In some alternate versions, second end plate (220) may comprise textured or rubberized feet or a textured bottom surface to prevent slipping of second end plate (220) when placed on a support surface.

First end plate (210) and second end plate (220) may comprise any suitable material, including but not limited to, fiberglass, wood, steel, soft or hardened carbon steel, stainless steel, aluminum, brass, copper, bronze, other suitable metals, polymeric plastics, polytetrafluoroethylene, polyethylene, polypropylene, nylon, and other suitable plastics. First end plate (210) and second end plate (220) may comprise the same material. In other embodiments, first end plate (210) and second end plate (220) may comprise different materials.

As shown in FIG. 12, back plate (216) extends between first end plate (210) and second end plate (220). One end of back plate (216) may be fixedly attached to first end plate (210). An opposite end of back plate (216) may be fixedly attached to second end plate (220). Back plate (216) may be fixedly attached to first end plate (210) and second end plate (220) by using one or more fasteners, welding, screws, bolts, or any other suitable device or method. Back plate (216) may comprise a substantially solid member, although this is not required. In some embodiments, first end plate (210), second end plate (220), or back plate (216) may also be constructed of a molded material, such as, for example plastic, metals, alloys, or other suitable materials. First end plate (210), second end plate (220), and back plate (216) may be configured to provide a snap-fit configuration for assembling together. Alternatively, first end plate (210), second end plate (220), and/or back plate (216) may be integrally formed as a single piece, or any other suitable construction as will be apparent to one of ordinary skill in the art in view of the teachings herein.

Back plate (216) may comprise any suitable material, including but not limited to, fiberglass, wood, steel, soft or hardened carbon steel, stainless steel, aluminum, brass, copper, bronze, other suitable metals, polymeric plastics, polytetrafluoroethylene, polyethylene, polypropylene, nylon, and other suitable plastics. Back plate (216) may comprise the same material as one or both of first end plate (210) and second end plate (220), although this is not required.

In the illustrated version, first cleaning roller (214) and second cleaning roller (222) are positioned between first end plate (210) and second end plate (220). First cleaning roller (214) and second cleaning roller (222) may be positioned such that the longitudinal axes of the rollers are parallel to each other, although this is not required. In alternate embodiments, first cleaning roller (214) and second cleaning roller (222) may be aligned so the longitudinal axes of the rollers are not parallel to each other. While the illustrated version demonstrates the use of two cleaning rollers, any number of cleaning rollers, including three, four, five, or more may be used. Other suitable numbers of cleaning rollers will be apparent to those of ordinary skill in the art in view of the teachings herein.

First cleaning roller (214) and second cleaning roller (222) may be of a length suitable to fit in frame (205) between first end plate (210) and second end plate (220). First cleaning roller (214) and second cleaning roller (222) may be an adequate length to accommodate various types and sizes of roller covers. In some embodiments, the lengths of frame (205), first cleaning roller (214), and second cleaning roller (222) may be adjustable to accommodate multiple types and sizes of rollers with a single cleaning device. First cleaning roller (214) and second cleaning roller (222) may be generally cylindrical in shape, although this is not required. First cleaning roller (214) and second cleaning roller (222) may also be of any suitable shape or contour. For example, one or both of first cleaning roller (214) and second cleaning roller (222) may have a curvy cylindrical shape, hour glass shape, or any other suitable shape. The shapes of first cleaning roller (214) and second cleaning roller (222) may complement each other. First cleaning roller (214) and second cleaning roller (222) may have the same diameter as each other or different diameters. Alternate versions having rollers of different diameters may result in first cleaning roller (214) and second cleaning roller (222) rotating at different speeds.

First cleaning roller (214) and second cleaning roller (222) may be configured to have a ribbed, studded, diamond shaped, or other textured surface suitable to aid the release of substances from a roller cover during cleaning, although this is not required. First cleaning roller (214) and second cleaning roller (222) may be configured to be textured such that the cleaning process does not damage the nap of a roller cover. First cleaning roller (214) and second cleaning roller (222) may be constructed of any suitable material, including but not limited to a molded material. In an alternate embodiment (not shown), a first portion of one or both of first cleaning roller (214) and second cleaning roller (222) may be textured, while a second portion of one or both of first cleaning roller (214) and second cleaning roller (222) may be substantially smooth.

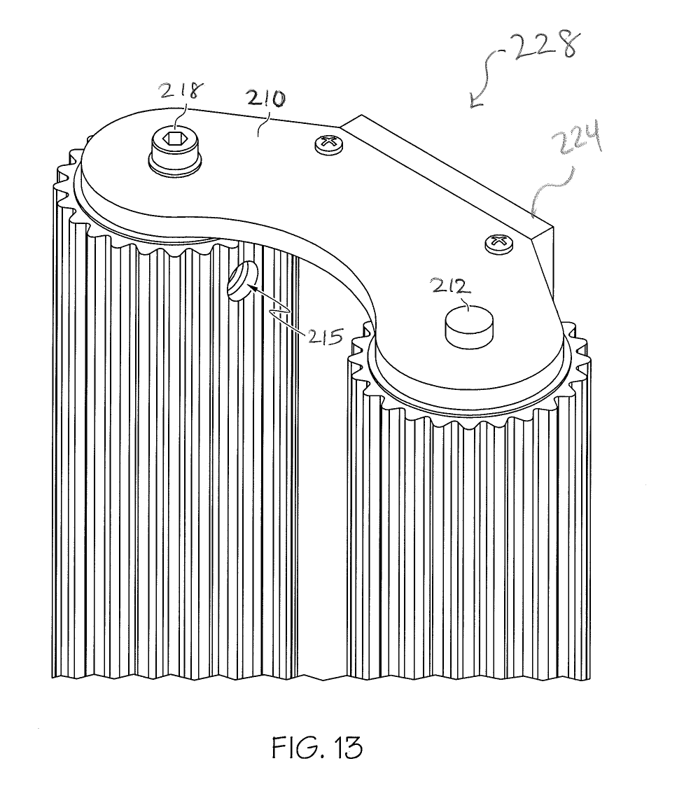

As shown in FIG. 13, first cleaning roller (214) comprises a coupling feature (215) which may be configured to facilitate communication between first cleaning roller (214) and driving feature (218). Thus, engaging coupling feature (215) may result in enabling driving feature (218) to cause rotation of first cleaning roller (214). Similarly, disengaging coupling feature (215) may result in driving feature (218) and first cleaning roller (214) no longer being in mechanical communication, thereby allowing first cleaning roller (214) to rotate independently of driving feature (218). Coupling feature (215) may comprise a set screw or any other suitable structure.

In an alternate embodiment (not shown), roller cover cleaning device (228) may comprise a locking mechanism configured to be transitioned between an engaged state and a disengaged state. When in the engaged state, the locking mechanism may substantially prevent rotational movement of first cleaning roller (214). When the locking mechanism is in the disengaged state, first cleaning roller (214) may rotate freely. Alternatively, locking mechanism may be configured to restrict/permit rotational movement of second cleaning roller (222) or both first cleaning roller (214) and second cleaning roller (222) together. The locking mechanism may be a switch, toggle, screw, or any other means suitable to prevent and allow rotation of the appropriate cleaning roller(s).

Frame (205) may receive first cleaning roller (214) and second cleaning roller (222) by engaging the ends of first cleaning roller (214) and second cleaning roller (222) with first end plate (210) and second end plate (220). A first end of first cleaning roller (214) may be inserted to engage driving feature (218), and a first end of second cleaning roller (222) may be inserted to engage engagement feature (212). Alternatively, frame (205) may receive first cleaning roller (214) and second cleaning roller (222) by engaging a portion other than the first end of first cleaning roller (214) and second cleaning roller (222).

In an alternate version, frame (205) may further comprise a linking feature comprising a gear, belt, or other suitable means of mechanically coupling first cleaning roller (214) and second cleaning roller (222). The linking feature may be configured to attach directly to first cleaning roller (214) and second cleaning roller (222).

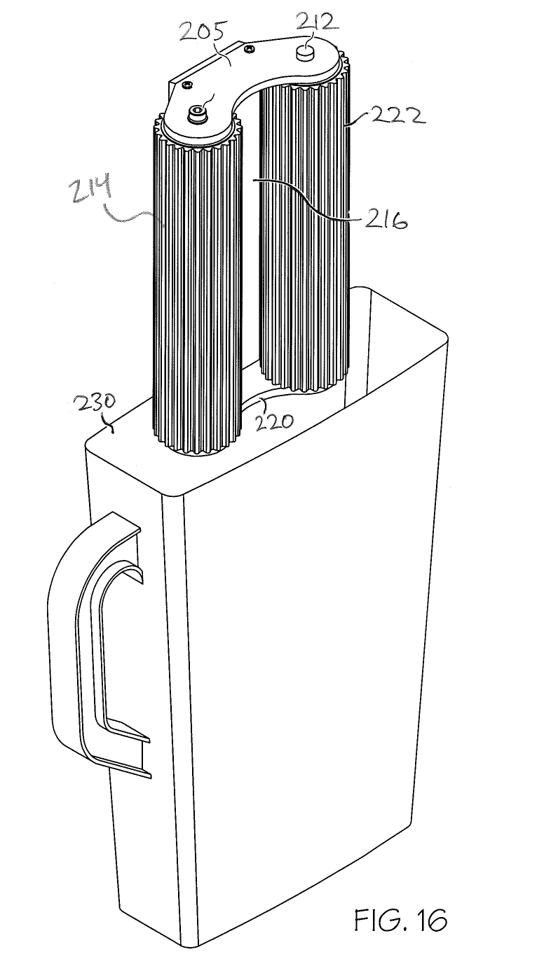

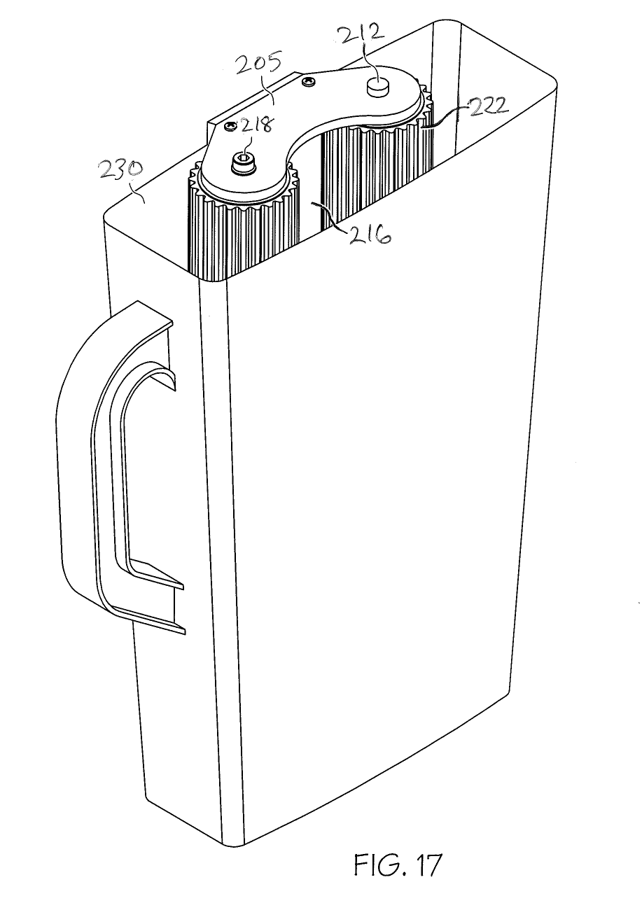

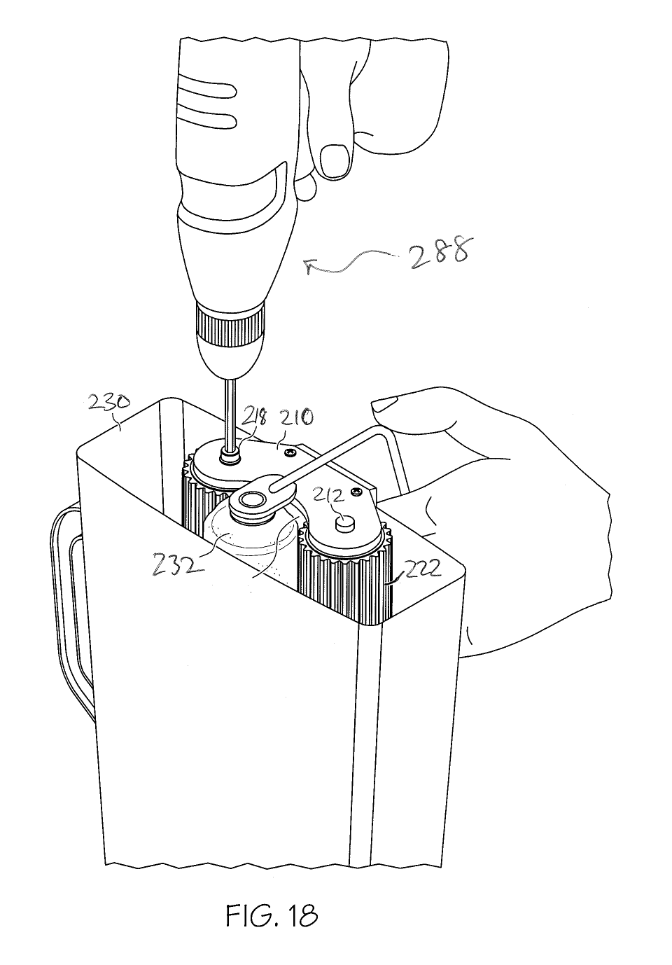

As shown in FIGS. 16-18, roller cover cleaning device (228) may be used in conjunction with a receptacle (230) as part of an alternate paint roller cover cleaning system. Receptacle (230) may comprise a generally rectangular or cylindrical compartment configured to receive roller cover cleaning device (228) and a roller cover (232) mounted on a rolling device into the interior of receptacle (230) while also allowing first cleaning roller (214), second cleaning roller (222) and roller cover (232) to rotate freely therein. It will be appreciated that roller cover (232) may be mounted to any suitable rolling device, including but not limited to a standard paint roller, roller cover cleaning device (10), and rolling device (310). Receptacle (230) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, polyvinyl chloride (PVC) and other suitable plastics. Of course, receptacle (230) may have any suitable inner and outer dimensions. Other suitable sizes and shapes for receptacle (230) will be apparent to those of ordinary skill in the art in view of the teachings herein. Receptacle (230) may be configured to contain a suitable amount of water or other fluid in order to facilitate the cleaning process and may further comprise a drain configured to drain the water from receptacle (230), although a drain is not required. Receptacle (230) may comprise an outer wall having a lip configured to receive and engage bracket (224) of frame (205) to support at least a portion of frame (205) when inserted into receptacle (230).

A method of using roller cover cleaning device (228) to clean roller cover (232) may include a method of cleaning roller cover (232) and a method of drying roller cover (232) or any combination thereof. One method of cleaning is accomplished by inserting roller cover cleaning device (228) into the interior cavity a receptacle (230). Receptacle (230) may contain a fluid such as water. But any suitable fluid; including but not limited to liquid soap, soapy water, paint cleaner, and paint thinner, may be used. Receptacle (230) may be filled with fluid sufficient to submerge at least a portion of roller cover cleaning device (228). After roller cover cleaning device (228) is inserted into receptacle (230), a driving device (288) or other means of actuating driving feature (218) may be used to engage and actuate driving feature (218). A roller cover (232) mounted on a rolling device may be inserted into receptacle (230) and positioned between first cleaning roller (214) and second cleaning roller (222) such that roller cover (332) remains substantially in contact with first cleaning roller (214) and second cleaning roller (222) during rotation. Driving device (288) may then be actuated by a user, thereby causing first roller (214). As first roller (214) rotates, roller cover (232) also rotates, thereby causing second cleaning roller (222) to rotate. By causing roller cover (232) to rotate while maintaining substantial contact with first cleaning roller (214) and second cleaning roller (222), unwanted substances may be released from roller cover (232). This operation may continue at a moderate speed for about ten seconds to twenty seconds. Of course, the speed and duration may be adjusted as appropriate to achieve desired results. Once a suitable amount of a substance is removed from roller cover (232), driving device (288) may be turned off. The fluid may then be drained or otherwise emptied from receptacle (230). These steps may be repeated any number of times until roller cover (232) is suitably clean.

An exemplary method of drying may be accomplished by placing roller cover cleaning device (228) in an empty or partially empty receptacle (230). After roller cover cleaning device (228) is inserted into receptacle (230), driving device (288) or other means may be used to actuate driving feature (218). Roller cover (232) which may be mounted on any suitable rolling device may be placed in receptacle (230) and positioned between first cleaning roller (214) and second cleaning roller (222). Driving device (288) is then actuated, causing first cleaning roller (214) to rotate. Rotation of first cleaning roller (214) may also cause second cleaning roller (222) and roller cover (232) to rotate. As roller cover (232) rotates, water or excess fluids are released from roller cover (232) and as a result, remain in receptacle (230) so that roller cover (232) may subsequently be removed in a substantially dry state. By way of example only, this operation may continue at a moderate speed for about ten seconds to twenty seconds. Of course, the speed and duration may be adjusted as appropriate to achieve desired results. Once a suitable amount of water or other fluid is removed from the roller cover (232), driving device (288) may be turned off. These steps may be repeated any number of times until roller cover (232) is suitably dry. Furthermore, once roller cover (232) is removed, driving device (288) may be actuated to cause first cleaning roller (214) and/or second cleaning roller (222) to rotate thus releasing water or other extraneous fluids from first cleaning roller (214) and second cleaning roller (222).

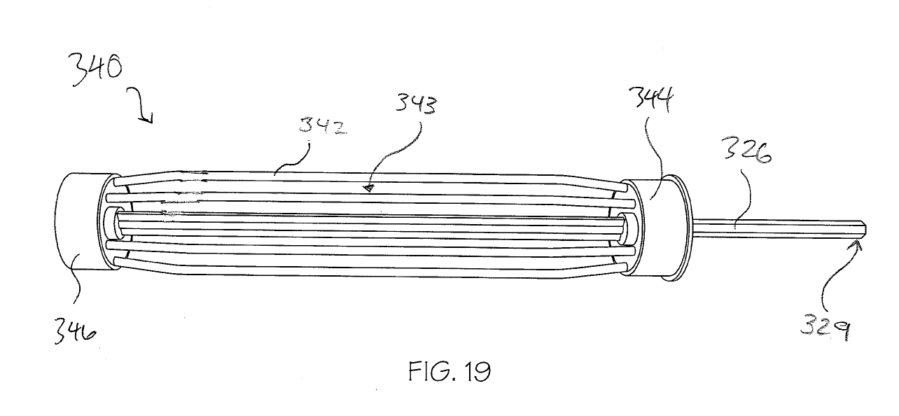

FIG. 19 depicts an alternate version of a rolling device (310) comprising a roller cover frame (340) and an extended drive shaft (326). The dimensions of roller cover frame (340) and its associated components may be varied in order to accommodate any suitable style and/or size roller cover, including but not limited to roller covers that are about 4 inches, 7 inches, 9 inches, 14 inches, and 18 inches in length. In the illustrated version, roller cover frame (340) comprises a substantially cylindrical cage (342) positioned between a first end cap (344) and a second end cap (346). While cage (342) comprises a plurality of rods forming a hollow cylinder comprising an interior cavity (343) in the illustrated embodiment, it will be appreciated that cage (342) may comprise a substantially solid member having an interior cylindrical cavity or have any other suitable configuration in alternate embodiments. As shown, first end cap (344) and second end cap (346) are positioned on opposite ends of roller cover frame (340). First end cap (344) and second end cap (346) may be fixedly secured to cage (342) such that first end cap (344), second end cap (346), and cage (342) rotate unitarily. First end cap (344) and second end cap (346) may comprise any suitable material, including but not limited to fiberglass, non-rusting metals, aluminum, stainless steel, brass, copper, bronze, other suitable metals, polymeric plastics, polytetrafluoroethylene, polyethylene, polypropylene, nylon, and other suitable plastics. In the illustrated example, first end cap (344) comprises an axial opening that extends through first end cap (344) along the central axis of first end cap (344), such that the axial opening is configured to receive an extended drive shaft (326).

Extended drive shaft (326) engages roller cover frame (340) such that extended drive shaft (326) and roller cover frame (340) rotate unitarily. Extended drive shaft (326) may fixedly or releasably engage roller cover frame (340). In the illustrated embodiment, extended drive shaft (326) extends between first end cap (344) and second end cap (346) along interior cavity (343). As shown, extended drive shaft (326) engages second end cap (346). It will be appreciated that extended drive shaft (326) may fixedly or releasably engage second end cap (346). In this version, extended drive shaft (326) further extends through the axial opening in first end cap (344) beyond first end cap (344). Extended drive shaft (326) further comprises an engagement end (329) configured to engage a driving device. In an alternate embodiment, extended drive shaft may engage first end cap (344) without extending into interior cavity (343) and without directly engaging second end cap (346). In such an embodiment, extended drive shaft (326) may fixedly or releasably engage first end cap (344).

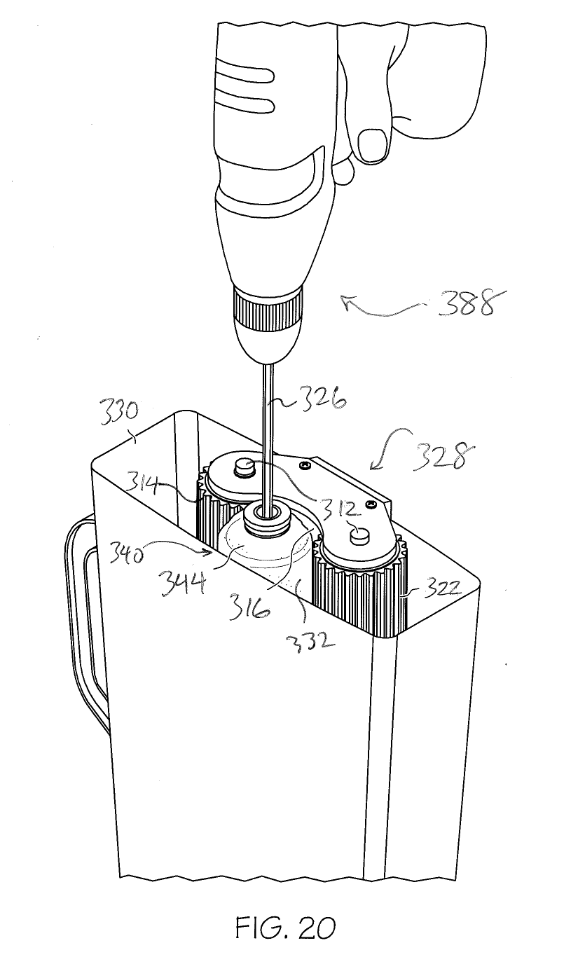

FIG. 20 depicts rolling device (310) being used with a roller cover cleaning device (328). Roller cover cleaning device (328) may be similar to roller cover cleaning device (228), although this is not required. Roller cover cleaning device (328) is inserted in a receptacle (330) for cleaning a roller cover (332). Roller cover (332) is mounted onto rolling device (310) by inserting roller cover frame (340) into the interior cavity of roller cover (332). Engagement end (329) of extended drive shaft (326) is engaged by a driving device (388). In this version, driving device (388) comprises a handheld drill, but driving device (388) may comprise any suitable means for driving rolling device (310). Rolling device (310) with roller cover (332) may be positioned against a first cleaning roller (314) and a second cleaning roller (322) such that roller cover (332) remains substantially in contact with first cleaning roller (314) and second cleaning roller (322) during rotation. First cleaning roller (314) and second cleaning roller (322) may be configured to be held in roller cover cleaning device (328) by an engagement feature (312). Receptacle (330) may contain a suitable amount of water or other suitable cleaning fluid. Driving device (388) may then be actuated by a user, thereby causing rolling device (310), roller cover frame (340), and roller cover (332) to rotate unitarily. Rotation of roller cover (332), which is in contact with first cleaning roller (314) and second cleaning roller (322), causes first cleaning roller (314) and second cleaning roller (322) to rotate. By rotating roller cover (332) while maintaining substantial contact with first cleaning roller (314) and second cleaning roller (322), unwanted substances or other debris is released from roller cover (332). After a sufficient amount of unwanted substance or other material is released from roller cover (332), driving device (388) may be disengaged and roller cover (332) may be removed from receptacle (330).

In some embodiments, water from receptacle (330) with unwanted paint or other material may be removed through a drain located on receptacle (330). Once the water or other fluid has been removed from receptacle (330), roller cover (332) may again be positioned within receptacle (330). Driving device (388) may again be engaged to rotate roller cover (332) so as to dry roller cover (332). During drying, roller cover (332) may be positioned against first and second cleaning rollers, but this is not required.

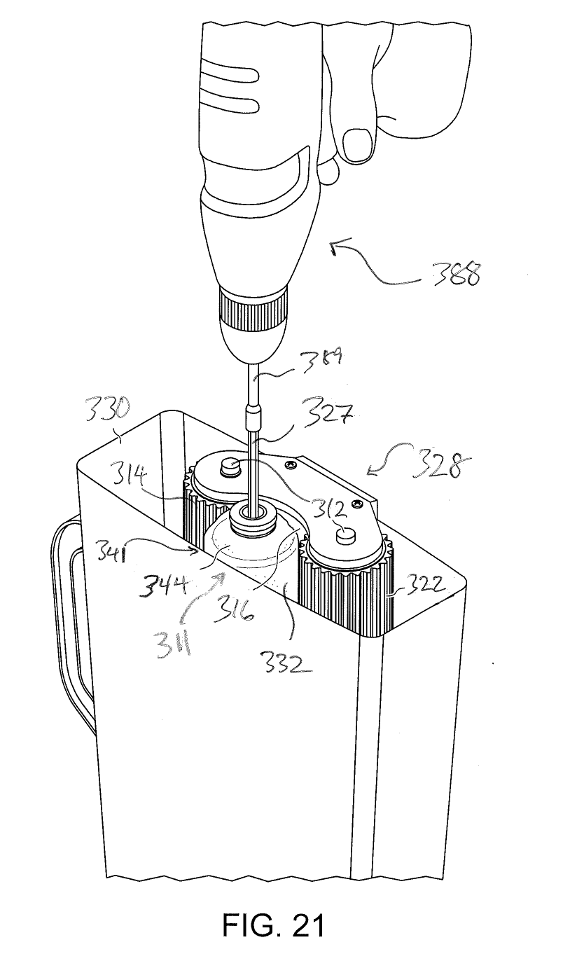

FIG. 21 depicts an alternative version of a rolling device (311) being used with a roller cover cleaning device (328). Rolling device (311) comprises a roller cover frame (341) having a modified extended drive shaft (327). Modified extended drive shaft (327) is configured to engage a bit (389). Bit (389) is engaged with driving device (388) so that modified extended drive shaft (327) may be used with any standard bit (389).

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. Thus, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A roller cover cleaning system comprising:
(a) a handle, wherein the handle comprises
(i) a gripping portion,
(ii) an attachment member, wherein the attachment member comprises a drive shaft opening extending through the attachment portion, wherein the drive shaft opening comprises a central axis,
(iii) a connecting member, wherein the connecting member extends between the gripping portion and the attachment member, and
(iv) an axle, wherein the axle comprises a hollow shaft extending substantially perpendicularly from the attachment member, wherein the hollow shaft comprises an interior cavity having a longitudinal central axis, wherein the longitudinal central axis of the interior cavity is aligned with the central axis of the drive shaft opening;
(b) a roller cover frame, wherein the roller cover frame is configured to engage the axle such that the roller cover frame is able to rotate freely about the axle, wherein the roller cover frame comprises
(i) a first end cap, wherein the first end cap comprises an axial opening extending there through, wherein the axial opening is configured to allow the axle to pass through the first end cap when the roller cover frame is positioned about the axle,
(ii) a second end cap, wherein the second end cap comprises an axial recess extending through at least a portion of the second end cap, wherein the axial recess is configured to receive an end of the axle, wherein the second end cap further comprises a driving feature, and
(iii) a cage, wherein the cage extends between the first end cap and the second end cap.

2. The roller cover cleaning system of claim 1, wherein the driving feature comprises an interior engagement feature and an exterior engagement feature.

3. The roller cover cleaning system of claim 2, wherein the interior engagement feature extends along a central axis into the axial recess of the second end cap.

4. The roller cover cleaning system of claim 2, wherein the exterior engagement feature extends along a central axis substantially perpendicular to an outer surface of the second end cap.

5. The roller cover cleaning system of claim 1, further comprising a drive shaft inserted through the drive shaft opening in the attachment member into the interior cavity of the axle, wherein the drive shaft comprises an engagement end configured to engage the driving feature of the second end cap.

6. The roller cover cleaning system of claim 5, wherein the drive shaft further comprises an attachment end configured to be placed in mechanical communication with a drive unit, such that upon being placed in mechanical communication with the drive unit, the drive shaft is operable to communicate rotational motion provided by the drive unit to the second end cap thereby causing the roller cover frame to rotate about the axle.

7. The roller cover cleaning system of claim 1, further comprising a receptacle comprising an interior cavity, wherein the receptacle is configured to receive at least a portion of the roller cover frame within the interior cavity of the receptacle.

8. The roller cover cleaning system of claim 7, wherein the receptacle further comprises a notch, wherein the notch is configured to receive and support a portion of the connecting member when at least a portion of the roller cover frame is inserted into the interior cavity of the receptacle.

9. The roller cover cleaning system of claim 7, further comprising a drive unit configured to support the receptacle, wherein the receptacle further comprises an opening configured to provide access to the driving feature of the second end cap, wherein the drive unit is configured to engage the driving feature such that the drive unit is operable to communicate rotational motion provided by the drive unit to the second end cap thereby causing the roller cover frame to rotate about the axle.

10. A roller cover cleaning system comprising:
(a) a frame, wherein the frame comprises
(i) a first end plate,
(ii) a second end plate, wherein the second end plate is spaced apart from the first end plate, and
(iii) a back plate, wherein the back plate extends between the first end plate and the second end plate;
(b) a first roller, wherein the first roller comprises a longitudinal central axis, wherein the first roller is positioned between the first end plate and the second end plate, wherein the first roller is configured to freely rotate about the longitudinal central axis of the first roller;
(c) a second roller, wherein the second roller comprises a longitudinal central axis, wherein the second roller is positioned between the first end plate and the second end plate, wherein the second roller is configured to freely rotate about the longitudinal central axis of the second roller;
(d) a driving feature, wherein the driving feature is configured to be in mechanical communication with at least one of the first roller or the second roller.

11. The roller cover cleaning system of claim 10, wherein the longitudinal central axis of the first roller is substantially parallel to the longitudinal central axis of the second roller.

12. The roller cover cleaning system of claim 10, wherein the first roller comprises a substantially cylindrical member, wherein the second roller comprises a substantially cylindrical member.

13. The roller cover cleaning system of claim 10, wherein at least a portion of the first roller comprises a ribbed surface, wherein at least a portion of the second roller comprises a ribbed surface.

14. The roller cover cleaning system of claim 10, further comprising a bracket, wherein the bracket is attached to the first end plate.

15. The roller cover cleaning system of claim 14, further comprising a receptacle, wherein the bracket is configured to engage the receptacle.

16. The roller cover cleaning system of claim 10, wherein the first roller is in mechanical communication with the second roller such that the first roller and the second roller rotate unitarily.

17. The roller cover cleaning system of claim 10, further comprising a drive unit, wherein the drive unit is configured to engage the driving feature such that rotational motion provided by the drive unit is communicated to at least one of the first roller or the second roller.

18. The roller cover cleaning system of claim 10, wherein the driving feature is positioned on the first end plate.

19. A roller cover cleaning system comprising:
(a) a roller cover cleaning device, wherein the roller cover cleaning device comprises
(i) a frame,
(ii) a first roller, wherein the first roller is engaged with the frame such that the first roller is rotatable about a longitudinal central axis of the first roller,
(iii) a second roller, wherein the second roller is engaged with the frame such that the first roller is rotatable about a longitudinal central axis of the second roller; and
(b) a rolling device, wherein the rolling device comprises
(i) a roller cover frame, wherein the roller cover frame comprises
(1) a first end cap,
(2) a second end cap, and
(3) a cage, wherein the cage extends between the first end cap and the second end cap;
(ii) an extended drive shaft, wherein the extended drive shaft comprises a first end and a second end, wherein the first end of the extended drive shaft engages the roller cover frame such that the extended drive shaft and the roller cover frame rotate unitarily, wherein the second end of the extended drive shaft is configured to engage a drive unit;
wherein the first roller and the second roller are spaced apart from each other such that a roller cover positioned about the roller cover frame placed between the first roller and the second roller engages the first roller and the second roller such that rotation of the roller cover via rotation of the roller cover frame results in simultaneous rotation of the first roller and the second roller.

20. The roller cover cleaning system of claim 19, wherein the extended drive shaft extends through an axial opening in the first end cap, wherein the second end of the extended drive shaft engages the second end cap.
